(19) United States
(12) Patent Application Publication
(10) Pub. No.: US 2021/0096962 A1
(43) Pub. Date: Apr. 1, 2021

(54) DATA BACKUP METHOD, DEVICE AND SYSTEM

(71) Applicant: ZTE CORPORATION, Guangdong (CN)

(72) Inventors: Kun YANG, Guangdong (CN); Chen LU, Guangdong (CN); Fang XIE, Guangdong (CN)

(73) Assignee: ZTE CORPORATION, Guangdong (CN)

(21) Appl. No.: 16/634,382

(22) PCT Filed: Feb. 7, 2018
(86) PCT No.: PCT/CN2018/075665

§ 371 Date: Jan. 27, 2020

(30) Foreign Application Priority Data
Jul. 28, 2017 (CN) 201710633057.9

(51) Int. Cl. G06F 11/14; G06F 3/06

(52) U.S. Cl. CPC G06F 11/1464; G06F 11/1469; G06F 3/067; G06F 3/0619; G06F 3/0652; G06F 11/1451

(57) ABSTRACT

The present disclosure provides a data backup method, device and system, the method includes: a second node receiving (S202) backup data transmitted by a first node according to a first cycle, where, the first node and the second node are cooperation nodes to each other; and the second node deleting (S204) the backup data of the first node locally stored in the second node according to a request of the first node.

### CROSS-REFERENCE TO RELATED APPLICATIONS

This is a National Stage Application, filed under 35 U.S.C. 371, of International Patent Application No. PCT/CN2018/075665, filed on Feb. 7, 2018, which claims priority to Chinese patent application No. 201710633057.9 filed on Jul. 28, 2017, contents of both of which are incorporated herein by reference in their entireties.

### TECHNICAL FIELD

The present disclosure relates to the field of communications and, in particular, a data backup method, device and system.

### BACKGROUND

According to backup methods in the related art, backup is mainly implemented between a main node and a backup node. The backup, which occurs between the main node and the backup node, requires consistency in hardware of the backup node and the main node. When the main node operates normally, the backup node does not access into the system, and only a backup operation is implemented on the main node; when the main node fails, the backup node is directly switched into the system for use; or the backup occurs between a main device and a backup device, when the main device fails, switching is implemented between the main device and the backup device, so that the backup device takes over work of the main device.

In the related art, data of the main node is backed up by a dedicated backup node in most cases. This requires a large number of dedicated backup nodes. These dedicated backup nodes only play a backup role when main nodes operate normally, and the backup nodes do not delete invalid backup data, which consumes a large amount of resources. Therefore the dedicated backup nodes are only applied to important nodes in the system. So a network which does not have any special important nodes, has a limited scale and is unable to support any backup nodes is not applicable to the related arts. With respect to the network unable to use the dedicated backup node, the present disclosure provides a method that does not need a dedicated backup node and can save node storage space by deleting invalid backup data.

### SUMMARY

Embodiments of the present disclosure provide a data backup method, device and system.

A data backup method is provided according to an embodiment of the present disclosure, the method includes steps described below. A second node receives backup data transmitted by a first node according to a first cycle, where the first node and the second node are cooperation nodes to each other; and the second node deletes backup data of the first node locally stored in the second node according to a request of the first node.

In an embodiment, after the second node performs data backup of the first node, the method further includes a step described below. When the first node is offline, the second node transmits the backup data of the first node to the data platform.

In an embodiment, the step in which the second node transmits the backup data of the first node to the data platform includes steps described below. The second node transmits a backup data recovery request message to the data platform; after receiving a backup data recovery acceptance message fed back by the data platform, the second node transmits the backup data of the first node locally stored in the second node to the data platform.

In an embodiment, after the second node transmits the backup data of the first node locally stored in the second node to the data platform, the method further includes steps described below. The second node receives a backup data confirmation message transmitted by the data platform; and the second node deletes the locally stored backup data of the first node transmitted to the data platform.

In an embodiment, the backup data includes data generated by the first node during a period from time of last transmission of backup data from the first node to the second node to current time.

In an embodiment, the backup data recovery request message includes start time and end time of backup of the first node in a cooperation node of the first node.

In an embodiment, the backup data recovery acceptance message includes start time and end time of recovery of the backup data of the first node desired by the data platform.

In an embodiment, the step in which the second node deletes the backup data of the first node locally stored in the second node according to the request of the first node includes a step described below. The second node deletes first backup data locally stored in the second node according to the request of the first node, where the first backup data is data transmitted by the first node to the data platform.

In an embodiment, the method further includes steps described below. When the second node receives the backup data transmitted by the first node, the second node deletes second backup data locally stored in the second node exceeding a local storage capacity to satisfy the local storage capacity, where the second backup data is determined according to backup time.

In an embodiment, after the second node receives the backup date transmitted by the first node according to the first cycle, the method further includes steps described below. The second node verifies correctness of the backup data; when the backup data is correct, the second node transmits a backup data reception confirmation message to the first node.

In an embodiment, the backup data confirmation message is fed back after the data platform confirms correctness of the received backup data.

In an embodiment, the second node is a terminal or gateway, and the first node is a terminal or gateway.

A data backup method is provided according to an embodiment of the present disclosure, the method includes steps described below. A first node transmits backup data to a second node according to a first cycle, where the first node and the second node are cooperation nodes to each other; the first node transmits original data of the first node to a data platform according to a second cycle; and the first node requests the second node to delete the backup data locally stored in the second node.

In an embodiment, the second cycle is greater than the first cycle.

In an embodiment, the method further includes a step described below. The first node transmits backup data to a third node according to a third cycle, where the first node and the third node are cooperation nodes to each other.

In an embodiment, when the first node is offline, each of the second node and the third node transmits a backup data recovery request message to the data platform; one of the second node or the third node receives a backup data recovery acceptance message transmitted by the data platform, the other of the second node or the third node receives a backup data recovery rejection message transmitted by the data platform; and the one of the second node or the third node receiving the backup data recovery acceptance message transmits the backup data of the first node to the data platform, and the other of the second node or the third node receiving the backup data recovery rejection message deletes the backup data of the first node.

In an embodiment, the backup data recovery request message includes start time and end time of local backup of the first node in a cooperation node of the first node.

In an embodiment, the backup data recovery acceptance message includes start time and end time of recovery of the backup data of the first node desired by the data platform.

In an embodiment, the step in which the first node requests the second node to delete the backup data locally stored in the second node includes a step described below. The first node requests the second node to delete first backup data locally stored in the second node, where the first backup data is data transmitted to the data platform by the first node.

In an embodiment, before the first node requests the second node to delete the backup data locally stored in the second node, the method further includes a step described below. The first node receives a reception confirmation message for the original data.

In an embodiment, the reception confirmation message is transmitted after the data platform verifies correctness of the original data.

In an embodiment, the second node is a terminal or gateway, and the first node is a terminal or gateway.

In an embodiment, the third node is a terminal or gateway.

According to another embodiment of the present disclosure, a data backup device applied to a second node is provided, the device includes a backup module and a deletion module. The backup module is configured to receive backup data transmitted by a first node according to a first cycle, where the first node and the second node are cooperation nodes to each other; and the deletion module is configured to delete backup data of the first node locally stored in the second node according to a request of the first node.

According to another embodiment of the present disclosure, another data backup device applied to a first node is provided, the device includes a transmitting module, an uploading module and a requesting module. The transmitting module is configured to transmit backup data to a second node according to a first cycle, where the first node and the second node are cooperation nodes to each other; the uploading module is configured to upload original data of the first node to a data platform according to a second cycle; and the requesting module is configured to request the second node to delete the backup data locally stored in the second node.

According to another embodiment of the present disclosure, a data backup system is provided, the system includes a first node, a second node and a data platform, the first node includes a transmitting module, an uploading module and a requesting module, the transmitting module is configured to transmit backup data to a second node according to a first cycle; the uploading module is configured to upload original data of the first node to a data platform according to a second cycle; and the requesting module is configured to request the second node to delete the backup data locally stored in the second node; the second node includes a backup module and a deletion module, the backup module is configured to receive backup data transmitted by the first node according to a first cycle; and the deletion module is configured to delete the backup data of the first node locally stored in the second node according to a request of the first node; the data platform is configured to receive the original data uploaded by the first node.

According to another embodiment of the present disclosure, a storage medium is provided, the storage medium is configured to store a program code for execution following steps:

backup data transmitted by a first node is received according to a first cycle, where the first node and a second node are cooperation nodes to each other; and

backup data of the first node locally stored in the second node is deleted according to a request of the first node.

Through the present disclosure, data of the first node is backed up by the second node, and backup data locally stored in the second node is deleted according to the request of the first node. In this way, on the premise of ensuring data backup, storage resources can be saved, and resource utilization rate is improved.

### BRIEF DESCRIPTION OF DRAWINGS

Drawings described herein are used to provide further understanding of the present disclosure and form a part of this application. The illustrative embodiments of the present disclosure and the description thereof are used to explain the present disclosure and do not constitute improper limitations to the present disclosure. In the drawings:

FIG. 1 is a schematic diagram of network architecture according to the present disclosure;

FIG. 2 is a flowchart of a data backup method according to an embodiment of the present disclosure;

FIG. 3 is a flowchart of another data backup method according to an embodiment of the present disclosure;

FIG. 4 is a block diagram of a data backup device according to an embodiment of the present disclosure;

FIG. 5 is a block diagram of another data backup device according to an embodiment of the present disclosure;

FIG. 6 is a block diagram of a data backup system according to an embodiment of the present disclosure;

FIG. 7 is a flowchart of node backup data transmission according to the present embodiment;

FIG. 8 is a flowchart of node backup data deletion according to an embodiment of the present disclosure;

FIG. 9 is a flowchart of node data recovery according to an embodiment of the present disclosure;

FIG. 10 is a flowchart of node data recovery with an embodiment of the present disclosure including multiple cooperation nodes.

### DETAILED DESCRIPTION

Hereinafter, the present disclosure will be described in details with reference to the drawings and embodiments. It should be noted that the embodiments in this application and features in the embodiments may be combined with each other without conflict.

It should be noted that terms of “first”, “second” and so on in the description, claims and drawings of the present disclosure are used to distinguish similar objects and are not necessarily used to describe a specific order or sequence.

### Embodiment One

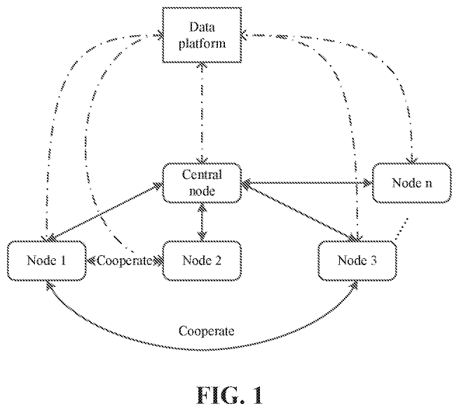

The embodiments of the present application may operate on a network architecture shown in FIG. 1, as shown in FIG. 1, FIG. 1 is a schematic diagram of network architecture of the embodiment of the present disclosure, the network architecture includes a data platform, common nodes (node 1 to node n), and a central node. This embodiment is applied to a network, in which a relationship between the central node and cooperation nodes has been determined, and each node needs to upload relevant data to the data platform. Each node has 0, 1 or 2 cooperation nodes, and each of the cooperation nodes may monitor a survival state of each other and back up related data of each other. The central node has all functions of the common nodes, and also a specific function lacking in the common nodes, namely, distribution of a cooperation relationship of all nodes in the network according to a network topology.

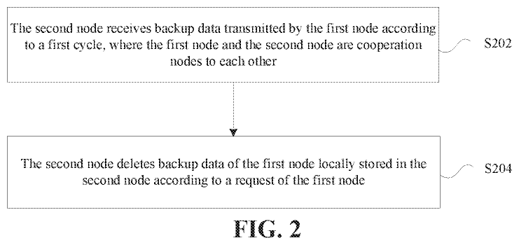

A data backup method operating on the above network architecture is provided according to the present embodiment, FIG. 2 is a flowchart of a data backup method according to an embodiment of the present disclosure, as shown in FIG. 2, the method includes steps described below.

Step S202, the second node receives backup data transmitted by the first node according to a first cycle, where, the first node and the second node are cooperation nodes to each other.

Step S204, the second node deletes backup data of the first node locally stored in the second node according to a request of the first node.

Through the above steps, data of the first node is backed up by the second node, then the backup data locally stored in the second node is deleted according to the request of the first node. In this way, on the premise of ensuring data backup, storage resources can be saved, and the resource utilization rate is improved.

In an embodiment, the second node as an execution subject of the above steps may be any node in the network, such as, but is not limited to, a gateway node, a terminal, a smart power grid node, a network element.

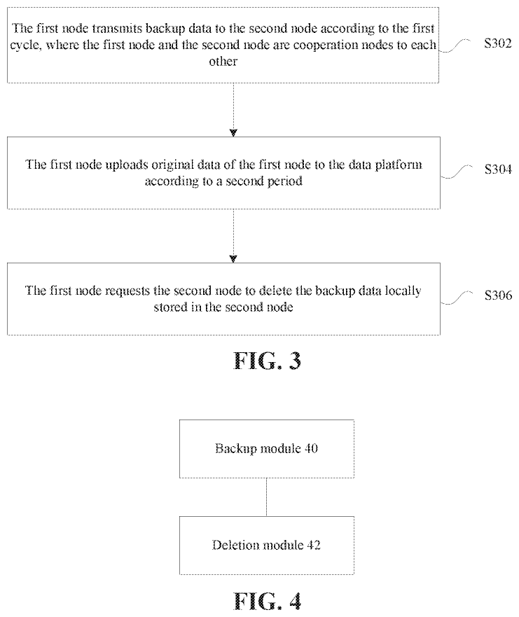

Another data backup method operating on the above network architecture is provided according to the present embodiment. FIG. 3 is a flowchart of another data backup method according to an embodiment of the present disclosure, as shown in FIG. 3, the method includes steps described below.

Step S302, the first node transmits backup data to the second node according to the first cycle, where, the first node and the second node are cooperation nodes to each other.

Step S304, the first node uploads original data of the first node to the data platform according to a second period; the second period may be greater than the first period.

Step S306, the first node requests the second node to delete the backup data locally stored in the second node.

In an embodiment, the first node as an execution subject of the above steps may be any node in the network, such as, but is not limited to, a gateway node, a terminal, a smart power grid node, a network element, and etc.

In an embodiment, after the second node performs data backup of the first node according to the first cycle, the method further includes a step described below. When the first node is offline, the second node transmits the backup data of the first node to the data platform.

In an embodiment, the step in which the second node transmits the backup data of the first node to the data platform includes steps described below.

S11, the second node transmits a backup data recovery request message to the data platform.

S12, after receiving a backup data recovery acceptance message fed back by the data platform, the second node transmits the backup data of the first node locally stored in the second node to the data platform.

In an embodiment, after the second node transmits the backup data of the first node locally stored in the second node to the data platform, the method further includes steps described below.

S21, the second node receives a backup data confirmation message transmitted by the data platform; in an embodiment, the backup data confirmation message is transmitted after the data platform confirms correctness of the received backup data.

S22, the second node deletes the locally stored backup data transmitted by the first node to the data platform.

In an embodiment, the backup data includes data generated by the first node during a period from time of last transmission of backup data from the first node to the second node to current time. That is, the backup data includes data generated within a time period.

In an embodiment, the backup data recovery request message includes start time and end time of backup of the first node in a cooperation node of the first node.

In an embodiment, the backup data recovery acceptance message includes start time and end time of recovery of the backup data of the first node desired by the data platform.

In an embodiment, the step in which the second node deletes the backup data of the first node locally stored in the second node according to the request of the first node includes a step described below: the second node deletes first backup data locally stored in the second node according to the request of the first node, where the first backup data is data transmitted by the first node to the data platform.

In an embodiment, deletion of the backup data may not be executed according to the request of the first node, and may include following steps: when the second node receives the backup data transmitted by the first node, the second node deletes second backup data locally stored in the second node exceeding a local storage capacity to satisfy the local storage capacity, where the second backup data is determined according to backup time. The earlier the time is, the higher priority the second backup data has.

In an embodiment, after the second node receives the backup data transmitted by the first node according to the first cycle, the method further includes steps described below.

S31, the second node verifies the correctness of the backup data.

S32, when the backup data is correct, the second node transmits a backup data confirmation message to the first node.

This specific process includes following steps: the first node generates the backup data according to the first cycle; the first node initiates a data backup request message to the second node; the second node transmits a backup transmission consent message; the first node transmits the backup data to the second node; the second node verifies the correctness of the backup data transmitted by the first node; and the second node transmits a data backup confirmation message to the first node.

In the present embodiment, when there are multiple cooperation nodes, the system further includes a third node, the first node transmits backup data to the third node according to a third cycle, where the first node and the third node are cooperation nodes to each other, and the data recovery process includes steps described below.

S41, when the first node is offline, each of the second node and the third node transmits a backup data recovery request message to the data platform.

S42, one of the second node or the third node receives a backup data recovery acceptance message transmitted by the data platform, and the other of the second node or the third node receives a backup data recovery rejection message transmitted by the data platform.

S43, the one of the second node or the third node receiving the backup data recovery acceptance message transmits the backup data of the first node to the data platform, and the other of the second node or the third node receiving the backup data recovery rejection message deletes the backup data of the first node.

In an embodiment, the step in which the first node requests the second node to delete the backup data locally stored in the second node includes a step described below. The first node requests the second node to delete first backup data locally stored in the second node, where the first backup data is data transmitted by the first node to the data platform.

In an embodiment, before the first node requests the second node to delete the backup data locally stored in the second node, the method further includes steps described below. The first node receives a reception confirmation message for the original data; in an embodiment, the reception confirmation message is transmitted by the data platform after the data platform verifies the correctness of the original data, meanwhile the reception confirmation message may be transmitted after the data platform stores the original data.

From the description of the above embodiments, those skilled in the art may clearly understand that the methods according to the above embodiments may be implemented by means of software plus necessary general-purpose hardware platforms, and of course, may also be implemented by means of hardware, but in many cases the former is a better embodiment. Based on this understanding, the present disclosure may be embodied in the form of a software product that is stored in a storage medium (e.g., a read-only memory (ROM)/random access memory (RAM), a magnetic disk, an optical disk) and includes several instructions to cause a terminal device (e.g., a mobile phone, a computer, a server, network device, etc.) to perform the methods described in various embodiments of the present disclosure.

### Embodiment Two

This embodiment further provides a data backup device and system. The device is used to implement the above embodiments and further embodiments, which have already been described and will not be described again. As used below, a term of “module” may be a combination of software and/or hardware that may implement a predetermined function. Although the device described in following embodiments may be implemented in software, an implementation of hardware, or a combination of software and hardware, is also possible and contemplated.

FIG. 4 is a block diagram of a data backup device according to an embodiment of the present disclosure, as shown in FIG. 4, the data backup device may be applied to a second node and the device includes a backup module 40 and a deletion module 42.

The backup module 40 is configured to receive backup data transmitted by a first node according to a first cycle, where the first node and the second node are cooperation nodes to each other.

The deletion module 42 is configured to delete backup data locally stored in the second node of the first node according to a request of the first node.

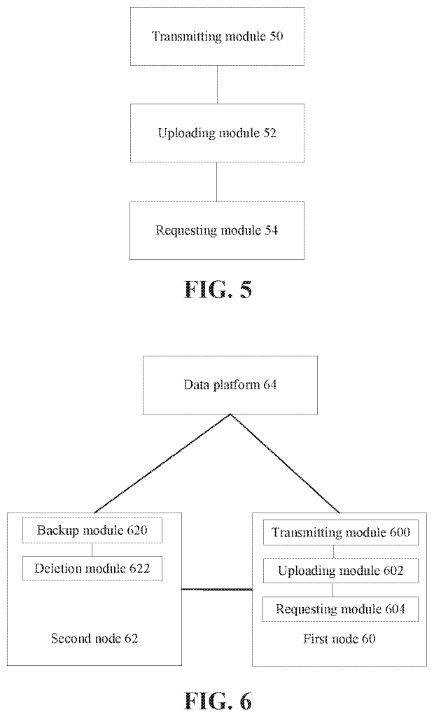

FIG. 5 is a block diagram of another data backup device according to an embodiment of the present disclosure, as shown in FIG. 5, the device may be applied to a first node and includes a transmitting module 50, an uploading module 52 and a requesting module 54.

The transmitting module 50 is configured to transmit backup data to a second node according to a first cycle, where the first node and the second node are cooperation nodes to each other.

The uploading module 52 is configured to upload original data of the first node to a data platform according to a second period; the second period may be greater than the first period.

The requesting module 54 is configured to request the second node to delete the backup data locally stored in the second node.

FIG. 6 is a block diagram of a data backup system according to an embodiment of the present disclosure, as shown in FIG. 6, the system includes a first node 60, a second node 62, and a data platform 64, where the first node and the second node are cooperation nodes to each other.

The first node 60 includes a transmitting module 600, an uploading module 602 and a requesting module 604.

The transmitting module 600 is configured to transmit backup data to the second node according to the first cycle.

The uploading module 602 is configured to upload the original data of the first node to the data platform according to a second period; the second period may be greater than the first period.

The requesting module 604 is configured to request the second node to delete the backup data locally stored in the second node.

The second node 62 includes a backup module 620 and a deletion module 622.

The backup module 620 is configured to receive backup data transmitted by the first node according to the first cycle.

The deletion module 622 is configured to delete the backup data of the first node locally stored in the second node according to a request of the first node.

The data platform 64 is configured to receive the original data uploaded by the first node.

It should be noted that each of the above modules may be implemented by software or hardware, and the latter may be implemented by following methods, but is not limited thereto: the above modules are all located in a same processor; alternatively, the above modules as any combination may be located in different processors.

### Embodiment Three

This embodiment is an embodiment according to the present disclosure, which is used to make a detailed and supplementary description of the present application in combination with specific scenes and embodiments:

this embodiment describes the purpose of cooperation inter-node backup, that is, to reduce data loss when nodes are offline abnormally.

The present embodiment describes rules for backup between cooperation nodes.

The present embodiment describes rules for a node to delete backup of a cooperation node of the node, that is, its cooperation node requests this node to delete corresponding backup after the data is uploaded to the data platform.

The present embodiment further describes two situations, i.e., one cooperation node and two cooperation nodes, and rules for a node to recovery data of an offline cooperation node to the data platform.

In a network in which the relationship between the central node and the cooperation nodes has been determined, all nodes need to upload relevant data to the data platform. In order to reduce the network pressure of the data platform, a time interval for a node to upload data to the data platform is relatively large, if a node is offline due to network abnormality and other reasons, which may cause relatively more data lost. First, the cooperation nodes back up data with each other at a relatively smaller time interval than the time interval for a node to upload data to the data platform. When a node monitors and discovers that its cooperation node is offline, the node uploads backup data to the data platform to reduce data loss.

The present embodiment also includes following embodiments.

A node data backup method embodiment

The present embodiment provides a node data backup method, which reduces data loss through data backup among cooperation nodes, when a node is offline abnormally.

The time interval of a backup process when nodes operate normally is denoted as t. The time interval needs to be mutually agreed by cooperation nodes according to network conditions and own conditions of the cooperation nodes after the cooperation nodes are selected, the time interval may be more than 2 times smaller than the time interval for a node to upload data to the data platform. Different cooperation nodes in the network may have different time intervals.

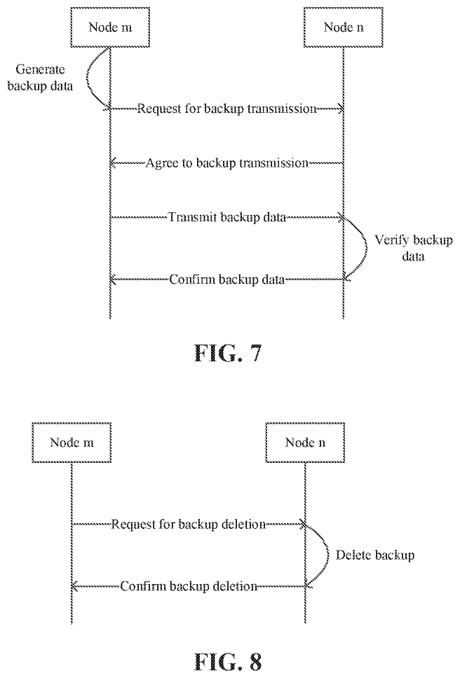

Please refer to FIG. 7, which is a diagram of a node backup data transmission flow according to an embodiment. This figure shows a backup process between any pair of cooperation nodes in the network, which needs to be implemented among all cooperation nodes in the network. Node m (corresponding to the first node in the above embodiments) and node n (corresponding to the second node in the above embodiments) are cooperation nodes to each other.

Step S101: a node m generates backup data.

Step S102: the node m initiates a backup request message to a node n.

Step S103: the node n transmits a backup transmission consent message to the node n.

Step S104: the node m transmits the backup data to the node n.

Step S105: the node n verifies correctness of the backup data transmitted by the node m.

Step S106: the node n transmits a backup data confirmation message to the node m.

The above process is only a one-way process for the node m to transmit the backup data to the node n, the node n may transmit the backup data to the node m in the same process to make this backup to be bidirectional.

The backup data may include all data generated during a period from time of last transmission of backup data transmitted from the node m to the node n to current time.

The backup request message may include a time stamp T, which is the time when the node m generates the backup data for this backup.

A node backup data deletion method embodiment

This embodiment needs to be executed after a node transmits data to the data platform. Steps to be performed between node m and node n refer to FIG. 8, which is a flowchart of node backup data deletion according to an embodiment of the present disclosure, the process includes steps described below.

Step S201: a node m transmits a backup deletion request message to a node n after the node m completes a process of uploading data to the data platform.

Step S202: the node n deletes corresponding backup data according to the backup deletion request.

Step S203: the node n transmits a backup deletion confirmation message to the node m.

The backup deletion request message may include a time stamp T, which is the time when the node m transmits data to the data platform.

The node n may delete all data in backup before T according to the time stamp T.

In an embodiment, when nodes have weak computing and storage capacity, and all data in a time interval between two times of uploading data to the data platform by a cooperation node may not be stored, the node backup data deletion method embodiment is changed into followings: the node m and the node n are cooperation nodes to each other, the node n deletes the backup data each time when the node m transmits the backup data, and data exceeding the capacity is deleted from earliest time to latest time.

A node data recovery method embodiment

This embodiment needs to be executed after a node detects that one of its cooperation nodes is offline. When node m only has one cooperation node n, when node n detects that its cooperation node m is offline, steps to be performed for data recovery between node n and the data platform refer to FIG. 9, which is a flowchart of node data recovery according to an embodiment of the present disclosure, the flowchart includes steps described below.

Step S301: a node n transmits a data recovery request message to the data platform.

Step S302: the data platform checks latest time where a node m uploads data.

Step S303: the data platform transmits a data recovery consent message to the node n.

Step S304: the node n searches backup data of the node m according to the data recovery consent message.

Step S305: the node n transmits the backup data of the node m to the data platform.

Step S306: the data platform verifies the backup data.

Step S307: the data platform transmits a backup data confirmation message to the node n.

Step S308: the node n deletes the backup data of the node m.

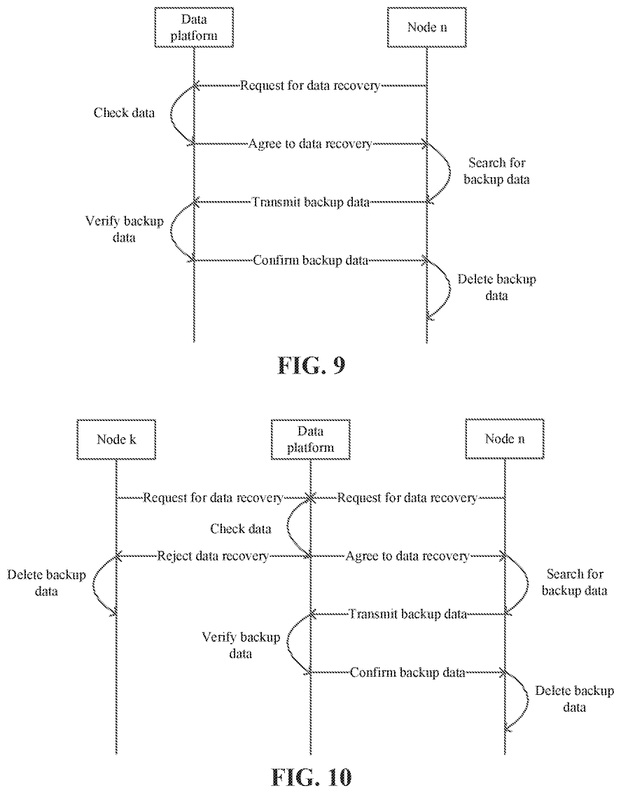

The node m has two cooperation nodes, i.e., a node n and a node k, when the node m is offline abnormally, steps to be performed for data recovery between the node n, the node k and the data platform refer to FIG. 10, which is a flowchart of node data recovery when an embodiment of the present disclosure includes multiple cooperation nodes, the recovery process includes steps described below.

Step S401: each of the node n and the node k transmits a data recovery request message to the data platform.

Step S402: the data platform checks latest time of node m uploading data and selects a node as a data recovery node according to the data recovery request messages transmitted by the node n and the node k, so the node n is selected here.

Step S403: the data platform transmits a data recovery consent message to the node n and a data recovery rejection message to the node k.

Step S404: the node n searches backup data of the node m according to the data recovery consent message, and the node k deletes the backup data of the node m.

Step S405: the node n transmits the backup data of the node m to the data platform.

Step S406: the data platform verifies the backup data.

Step S407: the data platform transmits a backup data confirmation message to the node n.

Step S408: the node n deletes the backup data of the node m.

Where, the data recovery request message may include start time and end time of backup of the node m. The data recovery consent message may include start time and end time of acquisition of the backup data of the node m desired by the data platform after the data platform checks the data.

Rules for the data platform to select a data recovery node include that the backup of node m included in the node may fill in more data of node m missing from the data platform, i.e., it is determined according to the start time and end time of the backup of node m included in the data recovery request message.

The cooperation node backup method and recovery method are provided according to this embodiment. According to the present backup method and recovery method, when some node in the network is offline abnormally, so data loss may be minimized. The node data backup method embodiment can redundantly save node data, so that the node data recovery method embodiment may be implemented after a node is offline abnormally. According to the node backup data deletion method embodiment, data without storage may be deleted in time, and node storage space can be saved. The node data recovery method embodiment can recover data loss caused by an abnormal offline of a node.

There are various application scenarios of the present embodiment, for example, a smart power grid ensures safety, reliability and economy of power consumption through monitoring power consumption load, making power supply plans and price adjustment. When some power devices in the power grid trip due to an overload, or some power devices are damaged due to natural/human factors, the smart power grid needs to minimize data loss caused by an abnormal offline of a device. However, due to a centralized structure of smart power grid at present, collected data is regularly reported to the data platform, which may cause more data loss when some power devices have problems. Therefore, it is necessary to backup data among cooperation nodes, when it is found that a cooperation node is unable to connect, the previously collected backup data will be reported to the data platform instead of the cooperation node, so as to minimize data loss.

### Embodiment Four

An embodiment of the present disclosure further provides a storage medium. In an embodiment, in this embodiment, the above storage medium may be configured to store program codes for executing following steps:

S1, backup data transmitted by a first node is received according to a first cycle, where, the first node and the second node are cooperation nodes to each other; and

S2, locally stored backup data of the first node is deleted according to a request of the first node.

In an embodiment, in this embodiment, the above storage medium may include, but is not limited to, a USB disk, a ROM, a RAM, a removable hard disk, a magnetic disk or an optical disk, and other various media that may store program codes.

In an embodiment, in this embodiment, the step in which the backup data transmitted by the first node is received according to the first cycle is executed by a processor according to the program codes stored in the storage medium, where, the first node and the second node are cooperation nodes to each other;

in an embodiment, in this embodiment, the step in which the locally stored backup data of the first node is deleted according to the request of the first node is executed by the processor according to the program codes stored in the storage medium.

In an embodiment, specific examples of this embodiment may refer to the embodiments described in the above-mentioned embodiments and alternative embodiments, and this embodiment will not be repeated here.

Obviously, those skilled in the art should understand that the above-mentioned modules or steps of the present disclosure may be implemented by a general-purpose computing device, these may be integrated on a single computing device, or distributed in a network containing multiple computing devices, alternatively, these modules or steps may be implemented by program codes executable by a computing device, so that they may be stored in a storage device for execution by the computing device, and in some cases, the steps shown or described may be performed in a sequence different from that herein, or they may be separately fabricated into individual integrated circuit modules, alternatively, multiple modules or steps among them may be fabricated into a single integrated circuit module. Therefore, the present disclosure is not limited to any specific combination of hardware and software.

The above description is only an embodiment of the present disclosure and is not intended to limit the present disclosure, various modifications and changes may be made to the present disclosure for those skilled in the art. Any modification, equivalent substitution, improvement, and so on made within spirit and principles of this disclosure shall be included within the protection scope of the present disclosure.

### INDUSTRIAL APPLICABILITY

By means of the present disclosure, on the premise of ensuring data backup, storage resources are saved, and resource utilization rate is improved.

1. A data backup method, comprising:
receiving, by a second node, backup data transmitted by a first node according to a first cycle, wherein the first node and the second node are cooperation nodes to each other; and
deleting, by the second node, backup data of the first node locally stored in the second node according to a request of the first node.

2. The method according to the claim 1, wherein after the second node performs data backup of the first node according to the first cycle, the method further comprises:
in a case of the first node being offline, transmitting, by the second node, the backup data of the first node to a data platform,
wherein transmitting, by the second node, the backup data of the first node to the data platform comprises:
transmitting, by the second node, a backup data recovery request message to the data platform; and
after receiving a backup data recovery acceptance message fed back by the data platform, transmitting, by the second node, the backup data of the first node locally stored in the second node to the data platform.

3. (canceled)

4. The method according to claim 2, wherein after transmitting, by the second node, the backup data of the first node locally stored in the second node to the data platform, the method further comprises:
receiving, by the second node, a backup data confirmation message transmitted by the data platform; and
deleting, by the second node, the locally stored backup data of the first node transmitted to the data platform,
wherein the backup data confirmation message is fed back after the data platform confirms correctness of the received backup data.

5. The method according to claim 1, wherein the backup data comprises: data generated by the first node during a period from time of last transmission of backup data from the first node to the second node to current time.

6. The method according to claim 3, wherein the backup data recovery request message comprises start time and end time of backup of the first node in a cooperation node of the first node,
or, the backup data recovery acceptance message comprises start time and end time of recovery of the backup data of the first node desired by the data platform.

7. (canceled)

8. The method according to claim 1, wherein deleting, by the second node, the backup data of the first node locally stored in the second node according to the request of the first node comprises:
deleting, by the second node, first backup data locally stored in the second node according to the request of the first node, wherein the first backup data is data transmitted by the first node to a data platform.

9. The method according to claim 1, further comprising:
in a case of receiving the backup data transmitted by the first node, deleting, by the second node, second backup data locally stored in the second node exceeding a local storage capacity to satisfy the local storage capacity, wherein the second backup data is determined according to backup time.

10. The method according to claim 1, wherein after receiving, by the second node, the backup data transmitted by the first node according to the first cycle, the method further comprises:
verifying, by the second node, correctness of the backup data;
in a case of the backup data being correct, transmitting, by the second node, a backup data reception confirmation message to the first node.

11. (canceled)

12. The method according to claim 1, wherein the second node is a terminal or gateway, and the first node is a terminal or gateway.

13. A data backup method, comprising:
transmitting, by a first node, backup data to a second node according to a first cycle, wherein the first node and the second node are cooperation nodes to each other;
uploading, by the first node, original data of the first node to a data platform according to a second cycle; and
requesting, by the first node, the second node to delete the backup data locally stored in the second node.

14. The method according to claim 13, wherein the second cycle is greater than the first cycle.

15. The method according to claim 13, further comprising:
transmitting, by the first node, backup data to a third node according to a third cycle, wherein the first node and the third node are cooperation nodes to each other,
wherein the method further comprises:
in a case of the first node being offline, transmitting, by each of the second node and the third node, a backup data recovery request message to the data platform;
receiving, by one of the second node or the third node, a backup data recovery acceptance message transmitted by the data platform, and receiving, by the other of the second node and the third node, a backup data recovery rejection message transmitted by the data platform; and
transmitting, by the one of the second node or the third node receiving the backup data recovery acceptance message, the backup data of the first node to the data platform, and deleting, by the other of the second node and the third node receiving the backup data recovery rejection message, the backup data of the first node.

16. (canceled)

17. The method according to claim 15, wherein the backup data recovery request message comprises start time and end time of local backup of the first node in a cooperation node of the first node,
or, the backup data recovery acceptance message comprises start time and end time of recovery of the backup data of the first node desired by the data platform.

18. (canceled)

19. The method according to claim 13, wherein requesting, by the first node, the second node to delete the backup data locally stored in the second node comprises:
requesting, by the first node, the second node to delete first backup data locally stored in the second node, wherein the first backup data is data transmitted by the first node to the data platform.

20. The method according to claim 13, wherein before requesting, by the first node, the second node to delete the backup data locally stored in the second node, the method further comprises:
receiving, by the first node, a reception confirmation message for the original data,
wherein the reception confirmation message is transmitted after the data platform verifies correctness of the original data.

21. (canceled)

22. The method according to claim 13, wherein the second node is a terminal or gateway, and the first node is a terminal or gateway.

23. The method according to claim 15, wherein the third node is a terminal or gateway.

24. A data backup device, applied to a second node, comprising:
a processor; and
a memory for storing instructions executable by the processor,
wherein when executing the instructions, the processor is configured to:
receive backup data transmitted by a first node according to a first cycle, wherein the first node and the second node are cooperation nodes to each other; and
delete backup data of the first node locally stored in the second node according to a request of the first node.

25. A data backup device, applied to a first node, comprising:
a processor; and
a memory for storing instructions executable by the processor,
wherein when executing the instructions, the processor is configured to implement the method according to claim 13.

26. (canceled)

27. A storage medium, comprising a stored program, wherein the program, when executed, performs the method according to claim 1.

28. (canceled)
